(19) United States
(12) Patent Application Publication
(10) Pub. No.: US 2015/0351123 A1
(43) Pub. Date: Dec. 3, 2015

(54) Techniques for Reverse Direction Grants on a Wireless Communication Channel

(71) Applicants: Solomon Trainin, Haifa (IL); Adrian P. Stephens, Cambridge (GB); Gadi Shor, Tel Aviv (IL)

(72) Inventors: Solomon Trainin, Haifa (IL); Adrian P. Stephens, Cambridge (GB); Gadi Shor, Tel Aviv (IL)

(21) Appl. No.: 14/293,838

(22) Filed: Jun. 2, 2014

(51) Int. Cl. H04W 72/14; H04W 74/04

(52) U.S. Cl. CPC H04W 72/14; H04W 74/04; H04W 84/12

(57) ABSTRACT

Examples are disclosed for a reverse direction grant (RDG) on a wireless communication channel between a first wireless device and a second wireless device. In some examples, an RDG may be used by the second wireless device to transmit data over a communication channel for a wireless local area network (WLAN) reserved for use by the first wireless device during a transmit opportunity (TxOP) time period. For these examples, the second wireless device may acknowledge the RDG but may wait for expected data to arrive before transmitting data over the communication channel. Other examples are described and claimed.

### TECHNICAL FIELD

Examples described herein are generally related to wireless devices in a wireless local area network (WLAN).

### BACKGROUND

Wireless devices in or associated with a wireless local area network (WLAN) may use wireless technologies such as Wi-Fi™. A wireless device using Wi-Fi wireless technologies may utilize WLAN standards that include Ethernet wireless standards (including progenies and variants) associated with the IEEE Standard for Information technology—Telecommunications and information exchange between systems—Local and metropolitan area networks—Specific requirements Part 11: WLAN Media Access Controller (MAC) and Physical Layer (PHY) Specifications, published March 2012, and/or later versions of this standard (“IEEE 802.11”). In some examples, a wireless device having a MAC capable of operating in compliance with IEEE 802.11 may implement a carrier sense multiple access with collision avoidance (CSMA/CA) scheme such as a distributed coordination function (DCF) to reserve a WLAN communication channel over a period of time. The reserved period of time may be referred to as a transmit opportunity (TxOP) time period. The TxOP time period may allow for a contention free time period via which a wireless device may by communicatively couple to one or more other wireless devise in the WLAN over the reserved communication channel.

### BRIEF DESCRIPTION OF THE DRAWINGS

FIG. 1 illustrates an example of a system.

FIG. 2 illustrates an example reverse direction grant (RDG) scheme.

FIG. 3 illustrates an example first logic flow.

FIG. 4 illustrates an example second logic flow.

FIG. 5 illustrates an example block diagram for a first apparatus.

FIG. 6 illustrates an example of a third logic flow.

FIG. 7 illustrates an example of a first storage medium.

FIG. 8 illustrates an example block diagram for a second apparatus.

FIG. 9 illustrates an example of a fourth logic flow.

FIG. 10 illustrates an example of a second storage medium.

FIG. 11 illustrates an example of a device.

### DETAILED DESCRIPTION

As contemplated by the present disclosure, a wireless device having a MAC capable of operating in compliance with IEEE 802.11 may implement a CSMA/CA scheme such as a DCF to reserve a WLAN communication channel over a TxOP time period. Various control messages such as request-to-send (RTS), clear-to-send (CTS), acknowledgements (ACKs), contention backoff as well as various inter-frame space parameters may be used in order for the wireless device to reserve the WLAN communication channel and the CSMA/CA-based MAC to function properly. These various control messages or parameters may result in a high protocol overhead.

One example solution to this high protocol overhead is a MAC-based solution known as a reverse direction (RD) protocol. In some examples, an RD initiator, originator or grantor may issue an RD grant (RDG) to another wireless device (RD responder) to allow for transmitting of data in both directions on the reserved WLAN communication channel without initiating a new transfer. For these examples, the RDG grant may be issued for a time period that is no greater than the TxOP time period. This example solution requires that an RD responder transmit a physical (PHY) layer protocol data unit (PPDU) a short inter frame space (SIFS) after receiving an RDG. If no data is ready for the RD responder to transmit, the RD responder does not have the option to postpone transmitting data even if the data is expected to be ready for transmitting within the TxOP time period. If an RD initiator still wants to enable an RD responder an opportunity to transmit data in the current TxOP time period, this example solution requires that the RD initiator continues to transmit RDGs throughout the TxOP time period even if the RD responder may not have data ready until later in the TxOP time period. If data is not ready until later in the TxOP time period, the RD initiator wastes power transmitting repeated RDGs and the RD responder also wastes power keeping receive circuitry powered up to receive these repeated RDGs. It is with respect to these and other challenges that the examples described herein are needed.

In some examples, techniques are implemented for reverse direction grants (RDGs) on a wireless communication channel. These techniques may include implementing a first example method that has a first wireless device (RD responder) receiving an RDG packet that indicates a grant for transmitting data over a communication channel for a WLAN reserved for use by a second wireless device (RD initiator or grantor). The first example method may also include the RD responder transmitting an acknowledgement packet to acknowledge the grant and indicate that data is expected to be transmitted over the communication channel within the TxOP time period. The RD responder may then transmit a CTS packet responsive to receiving data to transmit. The CTS packet may indicate to the RD initiator that the expected data is now ready to be transmitted over the communication channel using the grant. The RD responder may then transmit one or more data packets over the communication channel.

The techniques may also include implementing a second example method that has a first wireless device (RD initiator or grantor) transmitting an RDG packet to indicate a grant for a second wireless device (RD responder) to transmit data over a communication channel for a WLAN reserved for use by the RD initiator during a transmit opportunity (TxOP) time period. The second example method may also include the RD initiator receiving an acknowledgement packet to acknowledge the grant and may also indicate that data is expected to be transmitted over the communication channel within the TxOP time period. The RD initiator may then power down receiving circuitry for the communication channel to a low power mode. A CTS packet may then be received by the RD initiator. The CTS packet may indicate that the RD responder is now ready to transmit data included in one or more data packets over the communication channel using the grant. The RD initiator may then power up the receiving circuitry to receive the one or more data packets from the RD responder.

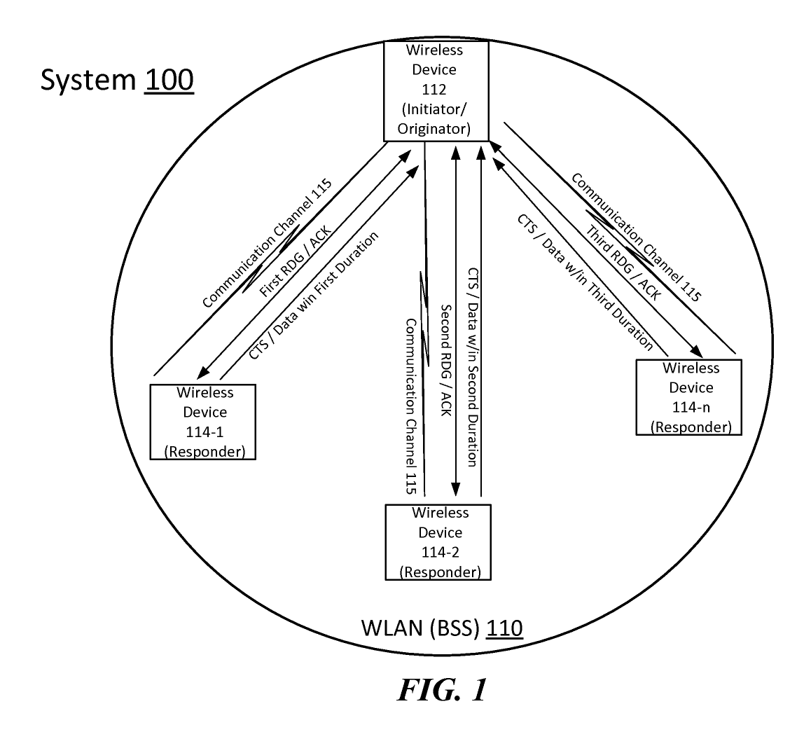

FIG. 1 illustrates an example system 100. In some examples, as shown in FIG. 1, system 100 includes a WLAN 110 that be configured as a basic service set (BSS) that includes a wireless device 112 (initiator/grantor) and wireless devices 114-1, 114-2 or 114-n, where n represents any positive integer greater than 2. In some examples, WLAN 110 may be arranged to operate according to the one or more wireless network technologies associated with IEEE 802.11. For these examples, wireless device 112 may be capable of reserving a communication channel for WLAN 110 such as communication channel 115 between at least one wireless device from among wireless devices 114-1 to 114-n via implementation of a CSMA/CA scheme. Communication channel 115 may be reserved for a TxOP period (e.g., a few milliseconds (ms)) for which wireless device 112 may serve as an RD initiator/grantor of one or more RDG packets transmitted to wireless device 114-1, wireless device 114-2 and/or wireless device 114-n. Thus, wireless devices 114-1, 114-2 and/or 114-n may be responders to a respective RDG packet transmitted from wireless device 112 that gives these wireless devices an opportunity to transmit data to wireless device 112.

According to some examples, wireless device 112 may send a first RDG packet to wireless device 114-1 and receive an acknowledgement packet of the first RDG from wireless device 114-1. The acknowledgement packet may indicate that data is expected to be transmitted over communication channel 115 within a time period indicated in the first RDG packet, the first recipient may utilize time less than the TxOP time period, the TxOP remainder may be redirected to another recipient. Once device 114-1 is ready to send data, a CTS packet may be transmitted to wireless device 112 to indicate that the expected data is ready to be transmitted over communication channel 115 using the first RDG. The CTS packet, for example, may cause wireless device 112 to power up receive circuitry (e.g., one or more directional antennas) to receive the data. Device 114-1 may then transmit one or more data packets including the received data over communication channel 115.

In some examples, subsequent second and third RDGs may be transmitted to wireless devices 114-2 and 114-n for respective second and third time periods, provided time remains within the TxOP period for these other two wireless devices to transmit data over communication channel 115. A similar process of acknowledgement packets, CTS packets and then data packets may occur as described above for wireless device 114-1.

As described more below, wireless devices such as wireless devices 112 and 114-1 to 114-n may include logic and/or features capable of powering down transmitting or receiving circuitry to lower power modes that may save power while an RD responder waits for expected data. The transmitting or receiving circuitry may then be powered back up responsive to receiving the expected data and/or responsive to transmitting of the data using an RDG over a communication channel such as communication channel 115. This power up and down of receiving or transmitting circuitry may be beneficial in some operating situations for with wireless devices are capable of implementing directional multi-gigabit (DMG) processes. For these DMG processes respective transmitting or receiving circuitry including directional antennas used to transmit primarily PPDUs having large data payloads may be temporarily powered down such that only smaller control packets (e.g., a CTS packet) may be transmitted or received over the communication channel using transmitting or receiving circuitry that may consume a relatively smaller amount of power.

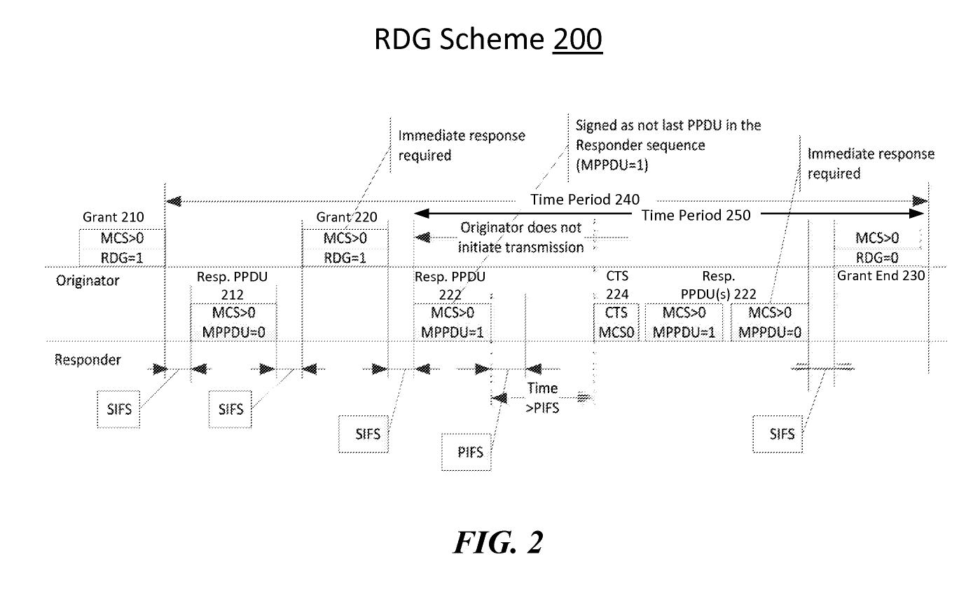

FIG. 2 illustrates an example reverse direction grant (RDG) scheme 200. According to some examples, RDG scheme 200 shows an interaction between an RD originator, grantor or initiator (e.g., wireless device 112) and a responder (e.g., wireless device 114-1) for transmitting RDG packets, responding to these packets and delaying the transmitting of data by the responder until expected data is ready to be transmitted. For these examples, both the RD originator and responder may be arranged to operate in compliance with IEEE 802.11 and may capable of implementing an RD protocol as described in IEEE 802.11 or an associated standard belonging to the family of IEEE 802.11 standards (e.g., IEEE 802.11ac or IEEE 802.11ad).

In some examples, one possible difference from the RD protocol as described by IEEE 802.11 and RD scheme 200 may be that the RD responder may generate an immediate (e.g., after a short inter frame space (SIFS)) response to the RD originator, even if the RD responder has no data ready to be transmitted over a communication channel reserved by the RD originator for a TxOP time period. This may act as a signal to the RD originator that the responder still “owns” a right to transmit next, even if that response is delayed. For example, during a time period asserted by the RD originator that is a subset or portion of the TxOP time period, the RD responder may be allowed any amount of time between a first frame or data packet transmitted from the RD responder and subsequent frames or data packets in a burst of transmissions over the communication channel.

For example, a first RDG packet, as shown in FIG. 2, may be transmitted by the RD originator at grant 210. Grant 210, for example, may include an RDG PPDU having a MAC protocol data unit (MPDU) that also includes a network address assigned to the RD responder, indicates a time period for the RDG that may be less than the TxOP time period and an RDG/more PPDU (MPPDU) bit set to 1 in a quality-of-service (QoS) field. Grant 210 may be transmitted over the communication channel using a non-control modulation and coding scheme (MCS) that is depicted in FIG. 2 as “MCS>0”. The RD responder may acknowledge grant 210 after a SIFS with response PPDU 212. However, for grant 210 the RD responder may not have data to be sent over the time period indicated in grant 210 and shown in FIG. 2 as time period 240. As a result of not having data to send, the RD responder may generate and transmit response PPDU 212 that may have an MPDU including an RDG/MPPDU bit set to 0 in a QoS field. PPDU 212 may also be transmitted over the communication channel using a non-control MCS that includes an MCS>0.

According to some examples, since the RD responder indicated no expectation of data to be sent by setting the MPPDU bit to 0, the RD originator upon receiving the response PPDU 212 may transmit a second RDG packet after a SIFS as grant 220. This second RDG packet may also be destined for the same RD responder, although the second RDG packet could be destined for a different wireless device RD responder, the same RD responder is shown for simplicity purposes. Grant 220 may having a MPDU that now allows for a second time period that may take into account less time remaining in the TxOP time period compared to grant 210. This second time period is shown in FIG. 2 as time period 250. For these examples, the RD responder may acknowledge grant 220 after a SIFS with response PPDU 220. For grant 220 the RD responder may now expect data to be received over the second time period indicated in grant 220. As a result of expecting data, the RD responder may generate and transmit response PPDU 214 that may have an MPDU including an RDG/MPPDU bit set to 1 in a QoS field. Also, for these examples, since data is not yet ready to be transmitted the QoS field may also indicate no data included with response PPDU 214 (e.g., a QoS Null indication). PPDU 214 may also be transmitted over the communication channel using a non-control MCS that includes an MCS>0.

In some examples, responsive to receiving PPDU 214, the RD originator may power down receiving circuitry to a low power mode after a point interface space (PIFS) based on PPDU 214 indicating that data is not yet ready to be transmitted. For example, in the low power mode, the RD originator may only be able to receive control PHY modulated frames or packets (e.g., transmitted using an MCS=0). Also, for RDG scheme 200 the RD originator may be inhibited or not allowed to transmit frames or packets until the end of time period 250 or until it receives the expected data from the RD responder.

According to some examples, after having no data ready to be transmitted after a SIFS amount of time following transmission of response PPDU 214, the RD responder may be allowed to send the expected data when the data is ready to be transmitted during the remainder of time period 250. Once data is ready to be transmitted, a clear to send (CTS) packet may be transmitted over the communication channel to the RD initiator responsive to the data being ready. For example, CTS 224 may be transmitted. As mentioned previously, the RD initiator may have powered down receive circuitry to a low power mode that may receive only frames or packets transmitted using an MCS=0. As a result, CTS 224 may have an MCS of 0 as shown in FIG. 2. The RD initiator, responsive to receiving CTS 224 may power up receive circuitry (e.g., switch antennas to a receive trained configuration) to receive one or more data packets from the RD responder. For these examples, as shown in FIG. 2, one or more response PPDU(s) 222 may be transmitted over the communication channel within time period 240. Each of the one or more response PPDU(s) 222 may have a separate MPDU that includes the RDG/MPPDU bit in the QoS field. In some examples, at least an initial response PDDU from response PPDU(s) 222 may have the RDG/MMPDU bit set to 1 and a last response PDDU may have the RDG/MMPDU bit set to 0 to indicate the last data packet frame transmitted by the RD responder. As shown in FIG. 2, response PPDU(s) 222 may be transmitted with an MCS>0.

In some examples, a SIFS after the last of the response PPDU(s) are received, the RD originator may determine that insufficient time remains for any more RDGs. For these examples, as shown in FIG. 2, a grant end 230 packet may be sent to the RD responder and may include an RDG PPDU having an MPDU having the RDG/more PPDU (MPPDU) bit set to 0 in a quality-of-service (QoS) field to indicate no more RDGs will be issued for the communication channel during the TxOP time period. As shown in FIG. 2, grant end 230 may be transmitted with an MCS>0.

In some examples, the RD responder may completely switch off its receiving and transmitting circuitry after transmitting 222 if no activity of the RD initiator is observed for time that is not shorter than PIFS.

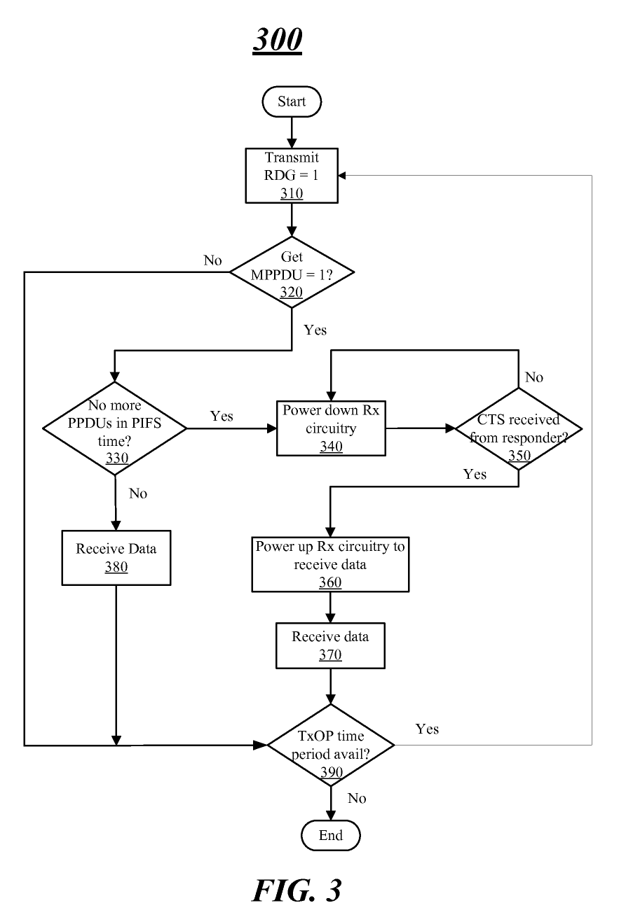

FIG. 3 illustrates an example first logic flow. In some examples, as shown in FIG. 3, the first logic flow includes logic flow 300. Logic flow 300 may depict actions taken by logic and/or features for an RD grantor, originator or initiator of RDGs for a reserved communication channel for a WLAN such as WLAN 110. The RD grantor, originator or initiator may be similar to wireless device 112 shown in FIG. 1 or the RD originator as mentioned above for FIG. 2. This disclosure is not limited to a wireless device 112 as described above for FIG. 1 or to the RD originator as mentioned above for RDG scheme 200 shown in FIG. 2.

Moving from the start to block 310 (Transmit RDG=1), logic and/or features at an RD initiator may be capable of causing an RDG packet or PPDU to be transmitted that has an MPDU that also includes a network address assigned to another wireless device in the WLAN. The RDG packet may indicate a time period for the RDG that is less than a TxOP time period for which the RD initiator may have contention free access to a communication channel for the WLAN. The MPDU may also have an RDG/MPPDU bit set to 1 in a QoS field that indicates that the wireless device for which the RDG packet is addressed may use the RDG if data is expected within the time period indicated. According to some examples, the RD initiator may use a non-control MCS such as an MCS>0 to transmit the RDG PPDU.

Proceeding from block 310 to decision block 320 (Get MPPDU=1?), logic and/or features at the RD initiator may receive an acknowledgement from the wireless device referred to now as an RD responder. In some examples, the RD responder may transmit a response PPDU having an MPDU including an RDG/MPPDU bit set to either 1 or 0 in a QoS field. If the RDG MPPDU bit is set to 1, the process moves to block 330. Otherwise the process moves to decision block 380.

Proceeding from decision block 320 to decision block 330 (No more PPDUs in PIFS time?), logic and/or features at the RD initiator may be able to determine whether the response PPDU indicated that data is not yet ready to be transmitted. If data is not ready to be transmitted the process moves to block 340. Otherwise, the process moves to block 380.

Moving from decision block 330 to block 340 (Power down Rx circuitry), logic and/or features at the RD initiator may power down receiving (Rx) circuitry to a low power mode responsive to the RD responder indicating that data is expected but not yet ready to be transmitted. For example, in the low power mode, the RD initiator may switch Rx circuitry to a control PHY state to at least be able to receive frames or packets transmitted from the RD responder using MCS0.

Proceeding from block 340 to decision block 350 (CTS received from Responder?), logic and/or features at the RD initiator may determine whether a CTS packet has been received from the RD responder. If a CTS packet has been received, the process moves to block 360. Otherwise, the process moves to block 340 where the Rx circuitry remains powered down to the low power mode.

Moving from decision block 350 to block 360 (Power up Rx circuitry to receive data), logic and/or features at the RD initiator may have received the CTS packet from the RD responder and may then power up the Rx circuitry to receive data.

Proceeding from block 360 to block 370 (Receive data), logic and/or features at the RD initiator may receive data transmitted from the RD responder in one or more data packets or frames.

Moving from decision block 320 or proceeding from blocks 380 or 370 to decision block 390 (TxOP time period avail?), logic and/or features at the RD initiator may then determine whether sufficient TxOP time in the TxOP time period is available for another RDG to be sent to either the same RD responder or to another wireless device in the WLAN. If sufficient TxOP time is available the process moves to block 310. Otherwise, the process comes to an end.

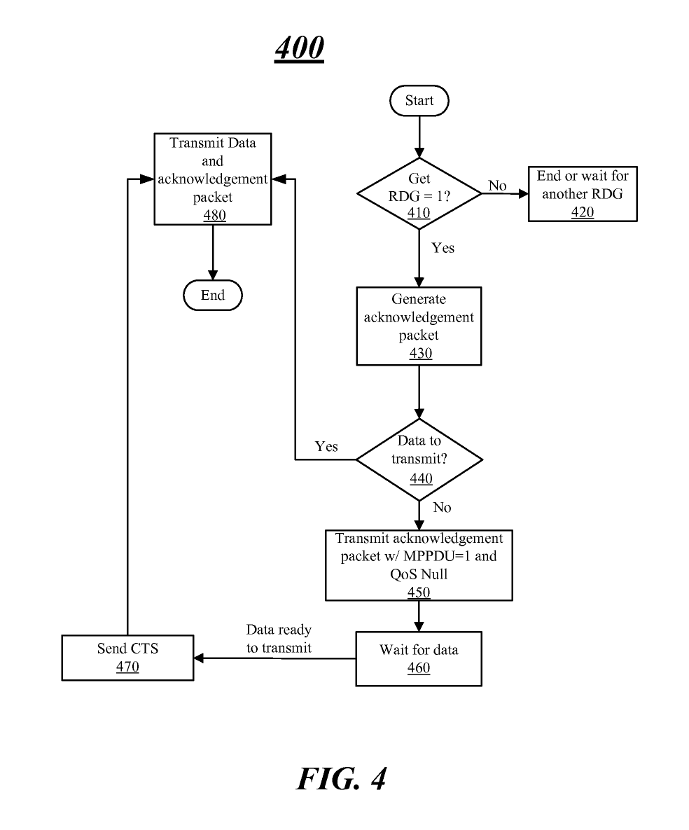

FIG. 4 illustrates an example second logic flow. In some examples, as shown in FIG. 4, the second logic flow includes logic flow 400. Logic flow 400 may depict actions taken by logic and/or features for a responder to an RDG packet for a reserved communication channel for a WLAN such as WLAN 110. The RD responder may be similar to wireless device 114-1 shown in FIG. 1 or the RD responder as mentioned above for FIG. 2. This disclosure is not limited to a wireless device 114-1 as described above for FIG. 1 or to the responder as mentioned above for RDG scheme 200 shown in FIG. 2.

Moving from the start to decision block 410 (Get RDG=1?), logic and/or features at a responder may determine whether an RDG packet or PPDU received from an RD initiator wireless device for a WLAN that has contention free or reserved access to a communication channel for the WLAN has included an MPDU in the RDG PPDU that has an RDG/MPPDU bit set to 1 in a QoS field. If the RDG/MPPDU bit is set to 0, the responder has not received an RDG and the process moves to block 420. Otherwise, in some examples, if the RDG/MPPDU bit is set to 1, the RD responder has received an RDG and the process moves to block 430. For these examples, an RDG=1 may indicate to the RD responder that the RDG may be used if data is expected within a time period indicated in the RDG PPDU.

Moving from decision block 410 to block 420 (End or wait for another RDG), logic and/or features at the RD responder may end the process or wait for another RDG and then return to decision block 410 if another RDG is received within the TxOP time period.

Moving from decision block 410 to block 430 (Generate acknowledgement packet), logic and/or features at the RD responder may cause an acknowledgement packet or response PPDU to be generated to acknowledge the RDG to the RD initiator and indicate that data is expected to be transmitted over the communication channel within the TxOP time period and/or time period indicated in the RDG packet or PPDU received from the RD initiator.

Proceeding from block 430 to decision block 440 (Data to transmit?), logic and/or features at the RD responder may determine whether the expected data is ready to be transmitted over the communication channel. If data is ready to be transmitted the process moves to block 480. Otherwise, the process moves to block 450.

Moving from decision block 440 to block 450 (Transmit acknowledgement packet w/MPPDU=1 and QoS Null), logic and/or features at the RD responder may cause the acknowledgement packet or response PPDU to be transmitted to the RD initiator. In some examples, the response PPDU may have an MPDU including an RDG/MPPDU bit set to 1 in a QoS field. Also, for these examples, since data is not yet ready to be transmitted, the QoS field may have a QoS Null indicator to indicate that the expected data is not included with the acknowledgement packet or response PPDU.

Moving from decision block 440 to block 450 (Wait for data), logic and/or features at the responder may wait for the expected data. Although not shown in FIG. 4, in some examples, the logic and/or features at the RD responder may power off Rx and Tx circuitry for the communication channel following transmission of the acknowledgement packet or response PPDU to the RD initiator and may then power on at least the Tx circuitry responsive to receiving the expected data. This powering off and on of Rx and/or Tx circuitry may be an attempt to conserve power.

Proceeding from block 460 to block 470 (Send CTS), logic and/or features at the RD responder may have received the expected data and may cause the responder to transmit a CTS packet to indicate to the RD initiator that the expected data is now ready to be transmitted over the communication channel.

Moving from decision block 410 or proceeding from block 470 to block 480 (Transmit Data and acknowledgement packet), logic and/or features at the RD responder may cause an acknowledgement packet and one or more data packets including the received data to be transmitted over the communication channel to the RD initiator. In some examples, at least the first PPDU may serve as the acknowledgement packet and have an MPDU including an RDG/MPPDU bit set to 1 in a QoS field and the last PPDU may have an MPDU including an RDG/MPPDU bit set to 0 to indicate the end of the data being transmitted. The process may then come to an end.

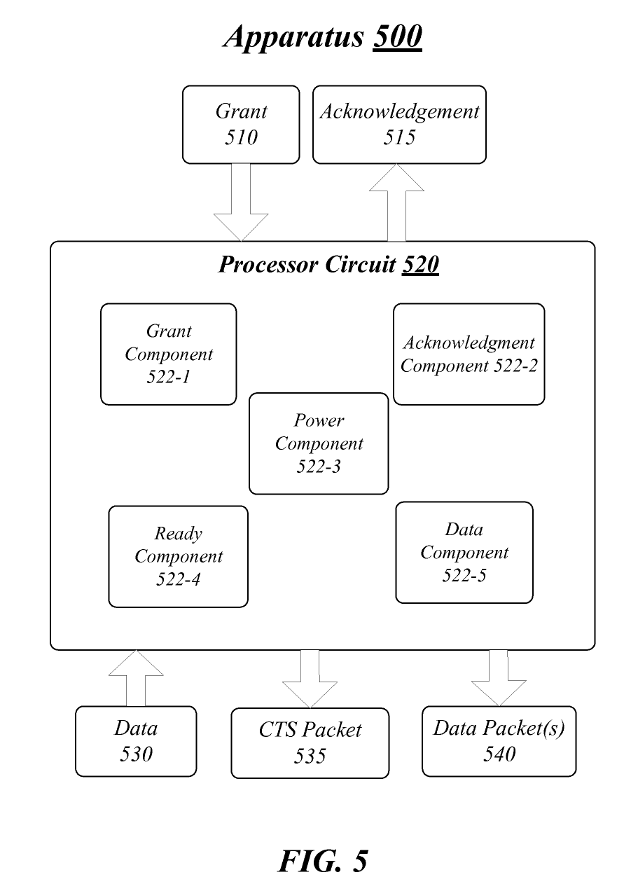

FIG. 5 illustrates a block diagram for a first apparatus. As shown in FIG. 5, the first apparatus includes an apparatus 500. Although apparatus 500 shown in FIG. 5 has a limited number of elements in a certain topology or configuration, it may be appreciated that apparatus 500 may include more or less elements in alternate configurations as desired for a given implementation.

The apparatus 500 may comprise a computer-implemented apparatus 500 having a processor circuit 520 arranged to execute one or more software modules or components 522-a. It is worthy to note that “a” and “b” and “c” and similar designators as used herein are intended to be variables representing any positive integer. Thus, for example, if an implementation sets a value for a=5, then a complete set of software components 522-a may include components 522-1, 522-2, 522-3, 522-4 or 522-5. The examples are not limited in this context.

According to some examples, apparatus 500 may be part of a wireless device arranged to operate in compliance with one or more wireless technologies such as those described in or associated with the IEEE 802.11 standards. For example, apparatus 500 may be arranged or configured to communicatively couple to another wireless device via a wireless communication channel for a WLAN established and/or operated according to IEEE 802.11ac, IEEE 802.11ad, IEEE 802.11ah or IEEE 802.11i. The examples are not limited in this context.

In some examples, as shown in FIG. 5, apparatus 500 includes processor circuit 520. Processor circuit 520 may be generally arranged to execute one or more software components 522-a. The processor circuit 520 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Qualcomm® Snapdragon®; Intel® Celeron®, Core (2) Duo®, Core i3, Core i5, Core i7, Itanium®, Pentium®, Xeon®, Atom® and XScale® processors; and similar processors. Dual microprocessors, multi-core processors, and other multi-processor architectures may also be employed as processor circuit 520. According to some examples processor circuit 520 may also be an application specific integrated circuit (ASIC) and components 522-a may be implemented as hardware elements of the ASIC.

According to some examples, apparatus 500 may include a grant component 522-1. Grant component 522-1 may be executed by processor circuit 520 to receive a RDG packet that indicates a grant for transmitting data over a communication channel for a WLAN reserved for use by another wireless device during a TxOP time period. For these examples, the grant may be included in grant 510 and may indicate a time period for which a wireless device including apparatus 500 may transmit data using the grant, provided the data is transmitted within the TxOP time period.

In some examples, apparatus 500 may also include an acknowledgement component 522-2. Acknowledgement component 522-2 may be executed by processor circuit 520 to cause an acknowledgement packet to be transmitted that acknowledges the grant and indicates that data is expected to be transmitted over the communication channel within the TxOP time period. For these examples, the acknowledgement may be included in acknowledgement 515. Also, in some examples, the acknowledgement may indicate that data is not yet ready for transmitting over the communication channel.

In some examples, apparatus 500 may also include a power component 522-3. Power component 522-3 may be executed by processor circuit 520 to power off Rx and Tx circuitry for the communication channel following transmission of the acknowledgement packet. Also, once the expected data is ready to be transmitted, power component 522-3 may power on at least the Tx circuitry to enable the data and a CTS packet (mentioned more below) to be transmitted to the other wireless device over the communication channel. For these examples, the expected data may be received with data 530.

According to some examples, apparatus 500 may also include a ready component 522-4. Ready component 522-4 may be executed by processor circuit 520 to cause a CTS packet to be transmitted to the other wireless device responsive to receiving data included in data 530. The CTS packet may be included in CTS packet 535 and may indicate to the other wireless device that the expected data is now ready to be transmitted over the communication channel using the grant.

According to some examples, apparatus 500 may also include a data component 522-5. Data component 522-5 may be executed by processor circuit 520 to cause one or more data packets that include the received data to be transmitted over the communication channel. For these examples, the one or more data packets may be included in data packet(s) 540. According to some examples, data component 522-5 may also cause an indication that the expected data has been transmitted and no additional data is expected during the TxOP time period. The indication may be included with a last data packet transmitted from among the one or more data packets included in data packet(s) 540.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

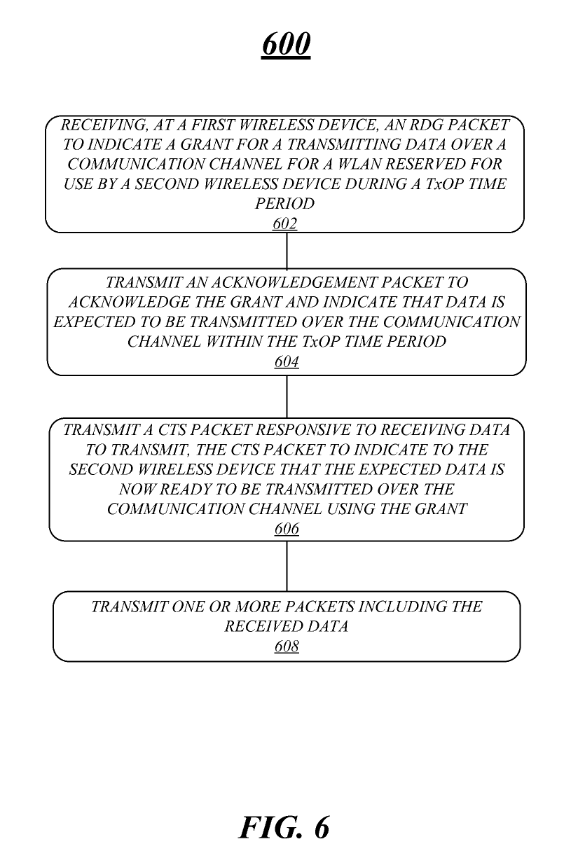

FIG. 6 illustrates an example of a third logic flow. As shown in FIG. 6, the third logic flow includes a logic flow 600. Logic flow 600 may be representative of some or all of the operations executed by one or more logic, features, or devices described herein, such as apparatus 500. More particularly, logic flow 600 may be implemented by one or more of a grant component 522-1, acknowledgement component 522-2, power component 522-3, ready component 522-4 or data component 522-5.

In the illustrated example shown in FIG. 6, logic flow 600 may receive, at a first wireless device, an RDG packet that indicates a grant for transmitting data over a communication channel for a WLAN reserved for use by a second wireless device during a TxOP time period. For these examples, grant component 522-1 may receive the RDG packet.

According to some examples, logic flow 600 at block 604 may transmit an acknowledgement packet to acknowledge the grant and indicate that data is expected to be transmitted over the communication channel within the TxOP time period. For these examples, acknowledgement component 522-2 may transmit the acknowledgement packet.

In some examples, logic flow 600 at block 606 may transmit a CTS packet responsive to receiving data to transmit. The CTS packet may indicate to the second wireless device that the expected data is now ready to be transmitted over the communication channel using the grant. For these examples, ready component 522-4 may cause the CTS packet to be transmitted over the communication channel.

According to some examples, logic flow 600 at block 608 may transmit one or more data packets including the received data over the communication channel. For these examples, data component 522-5 may cause the one or more data packets to be transmitted over the communication channel.

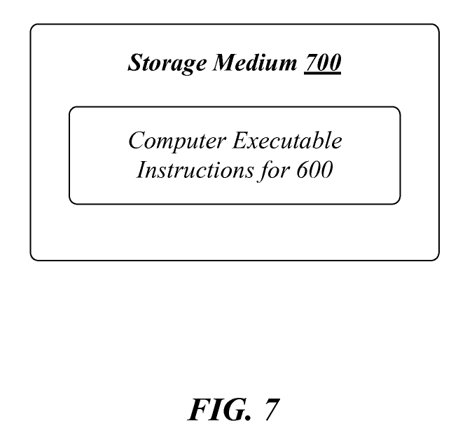

FIG. 7 illustrates an embodiment of a first storage medium. As shown in FIG. 7, the first storage medium includes a storage medium 700. Storage medium 700 may comprise an article of manufacture. In some examples, storage medium 700 may include any non-transitory computer readable medium or machine readable medium, such as an optical, magnetic or semiconductor storage. Storage medium 700 may store various types of computer executable instructions, such as instructions to implement logic flow 600. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

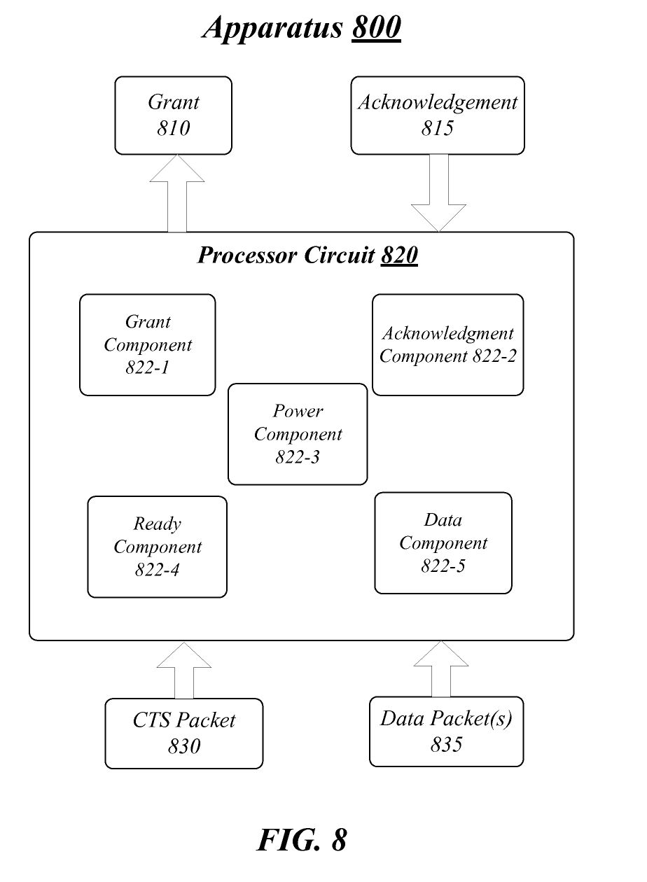

FIG. 8 illustrates a block diagram for a second apparatus. As shown in FIG. 8, the second apparatus includes an apparatus 800. Although apparatus 800 shown in FIG. 8 has a limited number of elements in a certain topology or configuration, it may be appreciated that apparatus 800 may include more or less elements in alternate configurations as desired for a given implementation.

The apparatus 800 may comprise a computer-implemented apparatus 800 having a processor circuit 820 arranged to execute one or more software modules or components 822-a. Similar to apparatus 500 for FIG. 5, “a” and “b” and “c” and similar designators may be variables representing any positive integer.

According to some examples, apparatus 800 may be part of a wireless device arranged to operate in compliance with one or more wireless technologies such as those described in or associated with the IEEE 802.11 standards. For example, apparatus 800 may be arranged or configured to communicatively couple to one or more wireless devices via a wireless communication link or channel established and/or operated according to IEEE 802.11ac, IEEE 802.11ad or IEEE 802.11i. The examples are not limited in this context.

In some examples, as shown in FIG. 8, apparatus 800 includes processor circuit 820. Processor circuit 820 may be generally arranged to execute one or more software components 822-a. The processor circuit 820 can be any of various commercially available processors to include, but not limited to, those previously mentioned for processing circuit 520 for apparatus 500. Dual microprocessors, multi-core processors, and other multi-processor architectures may also be employed as processor circuit 820. According to some examples processor circuit 820 may also be an application specific integrated circuit (ASIC) and components 822-a may be implemented as hardware elements of the ASIC.

According to some examples, apparatus 800 may include a grant component 822-1. Grant component 822-1 may be executed by processor circuit 820 to cause an RDG packet to be transmitted that indicates a grant for a second wireless device to transmit data over a communication channel for a WLAN reserved for use by the first wireless device that includes apparatus 800 during a TxOP time period. For these examples, the RDG packet may be included in grant 810 and transmitted to the second wireless device over the reserved communication channel.

In some examples, apparatus 800 may also include an acknowledgement component 822-2. Acknowledgement component 822-2 may be executed by processor circuit 820 to receive an acknowledgement packet that acknowledges the grant and indicates that data is expected to be transmitted over the communication channel within the TxOP time period. For these examples, the acknowledgement packet may be included in acknowledgement 815 and may have been received from the second wireless device over the communication channel.

In some examples, apparatus 800 may also include a power component 822-3. Power component 822-3 may be executed by processor circuit 820 to power down Rx circuitry for the communication channel to a low power mode. For these examples, power component 822-3 may cause the Rx circuitry to power down to a power mode that receives only control type packets (e.g., transmitted using an MCS=0).

According to some examples, apparatus 800 may also include a ready component 822-4. Ready component 822-4 may be executed by processor circuit 820 to receive a CTS packet that indicates the second wireless device is now ready to transmit data included in one or more data packets over the communication channel using the grant. For these examples, the CTS packet may be included in CTS packet 830.

In some examples, power component 822-3 may then cause the Rx circuitry to power up to receive the one or more data packets from the second wireless device. For these examples, the one or more data packets may be included in data packet(s) 835.

According to some examples, apparatus 800 may also include a data component 822-5. Data component 822-5 may be executed by processor circuit 820 to receive an indication that the expected data has been transmitted and no additional data is expected during the TxOP time period, the indication included with a last data packet transmitted from the second device from among the one or more data packets included in data packet(s) 835.

Various components of apparatus 800 and a wireless device implementing apparatus 800 may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Example connections include parallel interfaces, serial interfaces, and bus interfaces.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

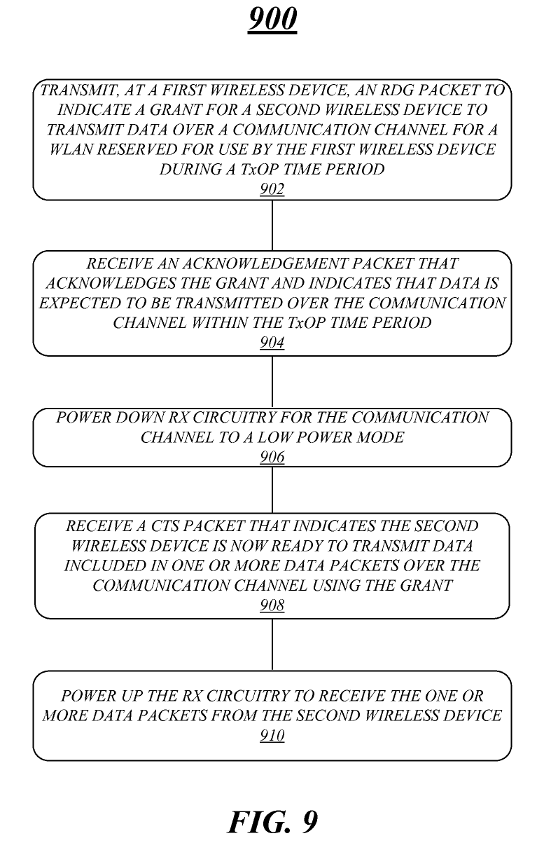

FIG. 9 illustrates an example of a fourth logic flow. As shown in FIG. 9, the fourth logic flow includes a logic flow 900. Logic flow 900 may be representative of some or all of the operations executed by one or more logic, features, or devices described herein, such as apparatus 800. More particularly, logic flow 900 may be implemented one or more of a grant component 822-1, acknowledgement component 822-2, power component 822-3, ready component 822-4 or data component 822-5.

In the illustrated example shown in FIG. 9, logic flow 900 at block 902 may transmit an RDG packet to indicate a grant for a second wireless device to transmit data over a communication channel for a WLAN reserved for use by a first wireless device during a transmit opportunity (TxOP) time period. For these examples, the first wireless device may include an apparatus 800 and a grant component 822-1 may cause the RDG packet to be sent to the second wireless device.

According to some examples, logic flow 900 at block 904 may receive an acknowledgement packet that acknowledges the grant and indicates that data is expected to be transmitted over the communication channel within the TxOP time period. For these examples, acknowledgement component 822-2 may receive the acknowledgement packet.

In some examples, logic flow 900 at block 906 may power down Rx circuitry for the communication channel to a low power mode. For these examples power component 822-3 may power down the Rx circuitry to the low power mode.

According to some examples, logic flow 900 at block 908 may receive a CTS packet that indicates the second wireless device is now ready to transmit data included in one or more data packets over the communication channel using the grant. For these examples, ready component 822-4 may receive the CTS packet indicating the second wireless device is ready to transmit data.

In some examples, logic flow 900 at block 910 may power up the Rx circuitry to receive the one or more data packets form the second wireless device. For these examples, power component 822-3 may power up the Rx circuitry.

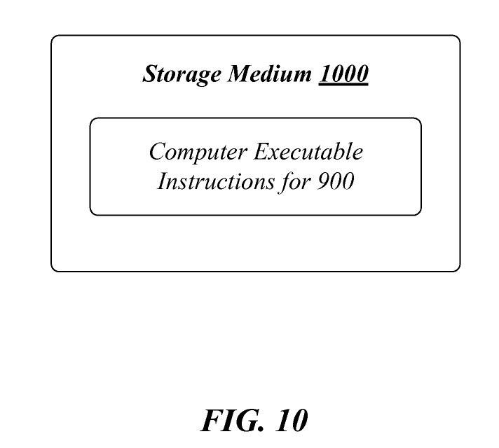

FIG. 10 illustrates an embodiment of a first storage medium. As shown in FIG. 10, the first storage medium includes a storage medium 1000. Storage medium 1000 may comprise an article of manufacture. In some examples, storage medium 1000 may include any non-transitory computer readable medium or machine readable medium, such as an optical, magnetic or semiconductor storage. Storage medium 1000 may store various types of computer executable instructions, such as instructions to implement logic flow 1000. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

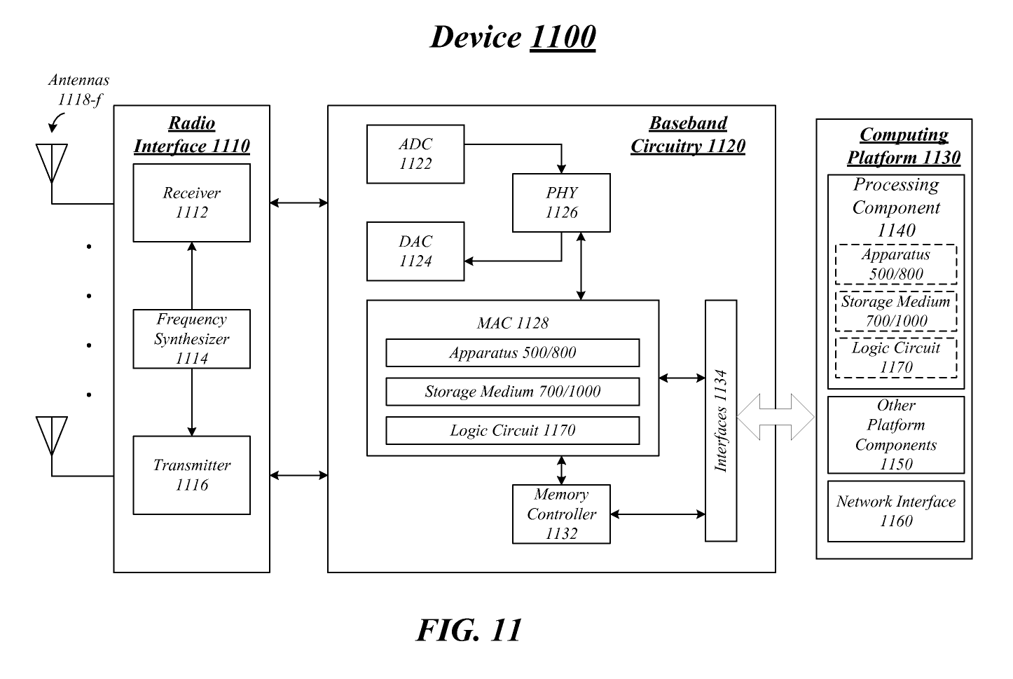

FIG. 11 illustrates an embodiment of a device 1100. In some examples, device 1100 may be configured or arranged for wireless communications in a wireless network. Device 1100 may implement, for example, apparatus 500/800, storage medium 700/1000 and/or a logic circuit 1170. The logic circuit 1170 may include physical circuits to perform operations described for apparatus 500/800. As shown in FIG. 11, device 1100 may include a radio interface 1110, baseband circuitry 1120, and computing platform 1130, although examples are not limited to this configuration.

The device 1100 may implement some or all of the structure and/or operations for apparatus 500/800, storage medium 700/1000 and/or logic circuit 1170 in a single computing entity, such as entirely within a single device. The embodiments are not limited in this context.

In one example, radio interface 1110 may include a component or combination of components adapted for transmitting and/or receiving single carrier or multi-carrier modulated signals (e.g., including complementary code keying (CCK) and/or orthogonal frequency division multiplexing (OFDM) symbols and/or single carrier frequency division multiplexing (SC-FDM symbols) although the embodiments are not limited to any specific over-the-air interface or modulation scheme. Radio interface 1110 may include, for example, a receiver 1112, a transmitter 1116 and/or a frequency synthesizer 1114. Radio interface 1110 may include bias controls, a crystal oscillator and/or one or more antennas 1118-f. In another embodiment, radio interface 1110 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 1120 may communicate with radio interface 1110 to process receive and/or transmit signals and may include, for example, an analog-to-digital converter 1122 for down converting received signals, a digital-to-analog converter 1124 for up converting signals for transmission. Further, baseband circuitry 1120 may include a baseband or physical layer (PHY) processing circuit 1126 for PHY link layer processing of respective receive/transmit signals. Baseband circuitry 1120 may include, for example, a processing circuit 1128 for medium access control (MAC)/data link layer processing. Baseband circuitry 1120 may include a memory controller 1132 for communicating with MAC processing circuit 1128 and/or a computing platform 1130, for example, via one or more interfaces 1134.

In some embodiments, PHY processing circuit 1126 may include a frame construction and/or detection module, in combination with additional circuitry such as a buffer memory, to construct and/or deconstruct communication frames (e.g., containing subframes). Alternatively or in addition, MAC processing circuit 1128 may share processing for certain of these functions or perform these processes independent of PHY processing circuit 1126. In some embodiments, MAC and PHY processing may be integrated into a single circuit.

Computing platform 1130 may provide computing functionality for device 1100. As shown, computing platform 1130 may include a processing component 1140. In addition to, or alternatively of, baseband circuitry 1120 of device 1100 may execute processing operations or logic for apparatus 500/800, storage medium 700/1000, and logic circuit 1170 using the processing component 1130. Processing component 1140 (and/or PHY 1126 and/or MAC 1128) may comprise various hardware elements, software elements, or a combination of both. Examples of hardware elements may include devices, logic devices, components, processors, microprocessors, circuits, processor circuits (e.g., processor circuit 1120), circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

Computing platform 1130 may further include other platform components 1150. Other platform components 1150 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Computing platform 1130 may further include a network interface 1160. In some examples, network interface 1160 may include logic and/or features to support network interfaces operated in compliance with one or more wireless broadband technologies such as those described in one or more standards associated with IEEE 802.11.

Device 1100 may be, for example, user equipment, a computer, a personal computer (PC), a desktop computer, a laptop computer, an ultrabook computer, a smartphone, a tablet computer, a notebook computer, a netbook computer, a tablet, a smart phone, embedded electronics, a gaming console, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof. Accordingly, functions and/or specific configurations of device 1100 described herein, may be included or omitted in various embodiments of device 1100, as suitably desired. In some embodiments, device 1000 may be configured to be compatible with protocols and frequencies associated with IEEE 802.11 Standards for WLANs, although the examples are not limited in this respect.

Embodiments of device 1100 may be implemented using single input single output (SISO) architectures. However, certain implementations may include multiple antennas (e.g., antennas 1118-f) for transmission and/or reception using adaptive antenna techniques for beamforming or spatial division multiple access (SDMA) and/or using multiple input multiple output (MIMO) communication techniques.

The components and features of device 1100 may be implemented using any combination of discrete circuitry, application specific integrated circuits (ASICs), logic gates and/or single chip architectures. Further, the features of device 1100 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 1100 shown in the block diagram of FIG. 11 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled”, “connected”, or “capable of being coupled” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

In some examples, an example first apparatus may include a processor circuit for a first wireless device. The example first apparatus may also include a grant component for execution by the processor circuit to receive a RDG packet that indicates a grant for a transmitting data over a communication channel for a WLAN reserved for use by a second wireless device during a TxOP time period. The example first apparatus may also include an acknowledgement component for execution by the processor circuit to cause an acknowledgement packet to be transmitted that acknowledges the grant and indicates that data is expected to be transmitted over the communication channel within the TxOP time period. The example first apparatus may also include a ready component for execution by the processor circuit to cause CTS packet to be transmitted responsive to receiving data to transmit. The CTS packet to indicate to the second wireless device that the expected data is now ready to be transmitted over the communication channel using the grant. The example first apparatus may also include a data component for execution by the processor circuit to cause one or more data packets that include the received data to be transmitted over the communication channel.

According to some examples, the first apparatus may also include a power component for execution by the processor circuit to power off receiving and transmitting circuitry for the communication channel following transmission of the acknowledgement packet. The power component may also be capable of powering on at least the transmitting circuitry to enable the data to be transmitted in the one or more data packets over the communication channel.

In some examples for the first apparatus, the data component may cause an indication that the expected data has been transmitted and no additional data is expected during the TxOP time period. For these examples, the indication included with a last data packet may be transmitted from among the one or more data packets.

According to some examples for the first apparatus, the communication channel may be reserved based on implementing a CSMA/CA scheme.

In some examples for the first apparatus, the first wireless device may be arranged to operate in compliance with one or more wireless communication standards or specifications associated with IEEE 802.11 standards including IEEE 802.11-2012.

According to some examples for the first apparatus, the RDG packet may include an RDG PPDU that also includes a network address assigned to the first wireless device and indicates a first time period for the grant that is less than the TxOP time period.

In some examples for the first apparatus, the RDG PPDU may be received over the communication channel using a non-control MCS that includes an MCS greater than 0.

According to some examples for the first apparatus, the acknowledgment packet may include a first response PPDU having an MPDU that includes an RDG/MPPDU bit set to 1 in a QoS field that also indicates no data with the first response PPDU.

In some examples for the first apparatus, the one or more data packets may include a plurality of second response PPDUs each having a separate MPDU that includes the RDG/MPPDU bit in the QoS field. For these examples, at least an initial second response PPDU may include the RDG/MPPDU bit set to 1 and a last second response PPDU may include the RDG/MPPDU bit set to 0 that may indicate no additional data is expected during the first time period.

According to some examples for the first apparatus, the first response PPDU and the plurality of second response PPDUs may be transmitted over the communication channel using a non-control MCS that includes an MCS greater than 0.

In some examples for the first apparatus, the CTS packet may be transmitted over the communication channel using a control MCS that includes an MCS equal to 0 that enables the second wireless device to receive the CTS packet while receiving circuitry at the second wireless device is powered down to a low power mode.

In some examples, an example first method may include receiving, at a first wireless device, an RDG packet that indicates a grant for transmitting data over a communication channel for a WLAN reserved for use by a second wireless device during TxOP time period. An acknowledgement packet may then be transmitted to acknowledge the grant and indicate that data is expected to be transmitted over the communication channel within the TxOP time period. A CTS packet may be transmitted responsive to receiving data to transmit. For these examples, the CTS packet may indicate to the second wireless device that the expected data is now ready to be transmitted over the communication channel using the grant. One or more data packets including the received data may then be transmitted over the communication channel.

According to some examples, the example first method may also include powering off receiving and transmitting circuitry for the communication channel following transmission of the acknowledgement packet and then powering on at least the transmitting circuitry to transmit the one or more data packets.

In some examples, the example first method may also include transmitting an indication that the expected data has been transmitted and no additional data is expected during the TxOP time period. For these examples, the indication may be included with a last data packet transmitted from among the one or more data packets.

According to some examples for the example first method, the communication channel may be reserved based on implementing a CSMA/CA scheme.

In some examples for the example first method, the first and second wireless devices may be arranged to operate in compliance with one or more wireless communication standards or specifications associated with IEEE 802.11 standards including IEEE 802.11-2012.

According to some examples for the example first method, the RDG packet may include an RDG PPDU that also includes a network address assigned to the first wireless device and indicates a first time period for the grant that is less than the TxOP time period.

In some examples for the example first method, the RDG PPDU may be received over the communication channel using a non-control MCS that includes an MCS greater than 0.

According to some examples for the example first method, the acknowledgment packet may include a first response PPDU having an MPDU including an RDG/MPPDU bit set to 1 in a QoS field that also indicates no data with the first response PPDU.

In some examples for the example first method, the one or more data packets may include a plurality of second response PPDUs each having a separate MPDU that includes the RDG/MPPDU bit in the QoS field. For these examples, at least an initial second response PPDU may include the RDG/MPPDU bit set to 1 and a last second response PPDU may include the RDG/MPPDU bit set to 0 to indicate no additional data is expected during the first time period.

According to some examples for the example first method, the first response PPDU and the plurality of second response PPDUs may be transmitted over the communication channel using a non-control MCS that includes an MCS greater than 0.

In some examples for the example first method, the CTS packet may be transmitted over the communication channel using an MCS that includes an MCS equal to 0 that enables the second wireless device to receive the CTS packet while receiving circuitry at the second wireless device is powered down to a low power mode.

According to some examples, an example first at least one machine readable medium may include a plurality of instructions that in response to being executed on a system at a first wireless device cause the system to receive an RDG packet that indicates a grant for transmitting data over a communication channel for a WLAN reserved for use by a second wireless device during a TxOP time period. The instructions may also cause the system to transmit an acknowledgement packet to acknowledge the grant and indicate that data is expected to be transmitted over the communication channel within the TxOP time period. The instructions may also cause the system to transmit a CTS packet responsive to receiving data to transmit, the CTS packet to indicate to the second wireless device that the expected data is now ready to be transmitted over the communication channel using the grant and transmit one or more data packets including the received data over the communication channel.

In some examples, the first at least one machine readable medium may also include instructions that cause the system to power off receiving and transmitting circuitry for the communication channel following transmission of the acknowledgement packet and power on at least the transmitting circuitry to transmit the one or more data packets.

According to some examples, the example first at least one machine may also include instructions to cause the system to transmit an indication that the expected data has been transmitted and no additional data is expected during the TxOP time period. For these examples, the indication may be included with a last data packet transmitted from among the one or more data packets.

In some examples for the example first at least one machine, the communication channel may be reserved based on implementing a CSMA/CA scheme.

According to some examples for the example first at least one machine, the first wireless device may be arranged to operate in compliance with one or more wireless communication standards or specifications associated with IEEE 802.11 standards including IEEE 802.11-2012.

In some examples for the example first at least one machine, the RDG packet may include an RDG PPDU that also includes a network address assigned to the first wireless device and indicates a first time period for the grant that is less than the TxOP time period.

According to some examples for the example first at least one machine, the RDG packet may include an RDG PPDU that also includes a network address assigned to the first wireless device and indicates the first time period.

In some examples for the example first at least one machine, the RDG PPDU may be received over the communication channel using a non-control MCS that includes an MCS greater than 0.

According to some examples for the example first at least one machine, the acknowledgment packet may include a first response PPDU having an MPDU that includes an RDG/MPPDU bit set to 1 in a QoS field that also indicates no data with the first response PPDU.

In some examples for the example first at least one machine, the one or more data packets may include a plurality of second response PPDUs each having a separate MPDU that includes the RDG/MPPDU bit. For these examples, at least an initial second response PPDU may include the RDG/MPPDU bit set to 1 and a last second response PPDU may include the RDG/MPPDU bit set to 0 to indicate no additional data is expected during the first time period.

According to some examples for the example first at least one machine, the first response PPDU and the plurality of second response PPDUs may be transmitted over the communication channel using a non-control MCS that includes an MCS greater than 0.

In some examples for the example first at least one machine, the CTS packet may be transmitted over the communication channel using a control MCS that includes an MCS equal to 0. For these examples the MCC equal to 0 may enable the second wireless device to receive the CTS packet while receiving circuitry at the second wireless device is powered down to a low power mode.

In some examples, an example second apparatus may include a processor circuit for a first wireless device. The example second apparatus may also include a grant component for execution by the processor circuit to cause a RDG packet to be transmitted that indicates a grant for a second wireless device to transmit data over a communication channel for a WLAN reserved for use by the first wireless device during a TxOP time period. The example second apparatus may also include an acknowledgement component for execution by the processor circuit to receive an acknowledgement packet that acknowledges the grant and indicates that data is expected to be transmitted over the communication channel within the TxOP time period. The example second apparatus may also include a power component for execution by the processor circuit to power down receiving circuitry for the communication channel to a low power mode. The example second apparatus may also include a ready component for execution by the processor circuit to receive a CTS packet that indicates the second wireless device is now ready to transmit data included in one or more data packets over the communication channel using the grant. The example second apparatus may also include the power component capable of causing the receiving circuitry to power up to receive the one or more data packets from the second wireless device.

According to some examples, the second apparatus may also include a data component for execution by the processor circuit to receive an indication that the expected data has been transmitted and no additional data is expected during the TxOP time period. For these examples, the indication may be included with a last data packet transmitted from the second device from among the one or more data packets.

In some examples for the second apparatus, the communication channel may be reserved based on implementing a CSMA/CA scheme.

According to some examples for the second apparatus, the first device may be arranged to operate in compliance with one or more wireless communication standards or specifications associated with IEEE 802.11 standards.

In some examples for the second apparatus, the RDG packet may include an RDG PPDU having an MPDU that also includes a network address assigned to the second wireless device indicates a time period for the grant that is less than the TxOP time period and an RDG/MPPDU bit set to 1 in a QoS field.

According to some examples for the second apparatus, the RDG PPDU may be transmitted over the communication channel using a non-control MCS that includes an MCS greater than 0.

In some examples for the second apparatus, the acknowledgment packet may include a first response PPDU having an MPDU including an RDG/MPPDU bit set to 1 in a QoS field that also indicates no data with the first response PPDU.

According to some examples for the second apparatus, the one or more data packets may include a plurality of second response PPDUs each having a separate MPDU that includes the RDG/MPPDU bit, at least an initial second response PPDU including the RDG/MPPDU bit set to 1 and a last second response PPDU including the RDG/MPPDU bit set to 0 to indicate no additional data is expected during the time period.

In some examples for the second apparatus, the first response PPDU and the plurality of second response PPDUs may be transmitted over the communication channel using a non-control MCS that includes an MCS greater than 0.

According to some examples for the second apparatus, the CTS packet may be received over the communication channel based on use of a control MCS that includes an MCS equal to 0 that enables the first wireless device to receive the CTS packet while the receiving circuitry has been powered down to the low power mode.

In some examples, an example second method may include transmitting, at a first wireless device, an RDG packet to indicate a grant for a second wireless device to transmit data over a communication channel for a WLAN reserved for use by the first wireless device during a TxOP time period. An acknowledgement packet may then be received that acknowledges the grant and indicates that data is expected to be transmitted over the communication channel within the TxOP time period. For these examples, receiving circuitry for the communication channel may then be powered down to a low power mode. Also, a CTS packet may be received that indicates the second wireless device is now ready to transmit data included in one or more data packets over the communication channel using the grant. The receiving circuitry may then be powered up to receive the one or more data packets from the second wireless device.

According to some examples, the example second method may also include receiving an indication that the expected data has been transmitted and no additional data is expected during the TxOP time period. For these examples, the indication included with a last data packet transmitted from the second device from among the one or more data packets.

In some examples, the example second method may also include transmitting a second RDG packet to indicate a second grant for a third wireless device to transmit data over the communication channel during the TxOP time period. For these examples, the second grant may have a time period no greater than an amount of remaining time for the TxOP time period. A second acknowledgement packet may then be received that acknowledges the second grant and indicates that data is expected to be transmitted by the third wireless device over the communication channel within the time period. The receiving circuitry for the communication channel may then be powered down to the low power mode. A second CTS packet may then be received that indicates the third wireless device is now ready to transmit other data over the communication channel using the second grant and the receiving circuitry may then be powered up to receive one or more second data packets from the third wireless device including the other data.

According to some examples for the example second method, the communication channel may be reserved based on implementing a CSMA/CA scheme.

In some examples for the example second method, the first and second wireless devices may be arranged to operate in compliance with one or more wireless communication standards or specifications associated with IEEE 802.11 standards.

According to some examples for the example second method, the RDG packet may include an RDG PPDU having an MPDU that also includes a network address assigned to the second wireless device, indicates a time period for the grant that is less than the TxOP time period and an RDG/MPPDU bit set to 1 in a QoS field.

In some examples for the example second method, the RDG PPDU may be transmitted over the communication channel using a non-control MCS that includes an MCS greater than 0.

According to some examples for the example second method, the acknowledgment packet may include a first response PPDU having an MPDU including an RDG/MPPDU bit set to 1 in a QoS field that also indicates no data with the first response PPDU.

In some examples for the example second method, the one or more data packets may include a plurality of second response PPDUs each having a separate MPDU that includes the RDG/MPPDU bit, at least an initial second response PPDU including the RDG/MPPDU bit set to 1 and a last second response PPDU including the RDG/MPPDU bit set to 0 to indicate no additional data is expected during the time period.

According to some examples for the example second method, the first response PPDU and the plurality of second response PPDUs may be transmitted over the communication channel using a non-control MCS that includes an MCS greater than 0.

In some examples for the example second method, the CTS packet may be received over the communication channel based on use of a control MCS that includes an MCS equal to 0. For these examples, the MCS equal to 0 may enable the first wireless device to receive the CTS packet while the receiving circuitry is powered down to the low power mode.

According to some examples, an example second at least one machine readable medium may include a plurality of instructions that in response to being executed on a system at a first wireless device cause the system to transmit an RDG packet to indicate a grant for a second wireless device to transmit data over a communication channel for a WLAN reserved for use by the first wireless device during a TxOP time period. The instructions may also cause the system to receive an acknowledgement packet that acknowledges the grant and indicates that data is expected to be transmitted over the communication channel within the TxOP time period. The instructions may also cause the system to power down receiving circuitry for the communication channel to a low power mode, receive a CTS packet that indicates the second wireless device is now ready to transmit data included in one or more data packets over the communication channel using the grant and power up the receiving circuitry to receive the one or more data packets from the second wireless device.

In some examples, the second at least one machine readable medium may include instructions to further cause the system to receive an indication that the expected data has been transmitted and no additional data is expected during the TxOP time period. For these examples, the indication may be included with a last data packet transmitted from the second device from among the one or more data packets.

According to some examples for the second at least one machine readable medium, the instructions may further cause the system to transmit a second RDG packet to indicate a second grant for a third wireless device to transmit data over the communication channel during the TxOP time period. For these examples, the second grant may have a time period no greater than an amount of remaining time for the TxOP time period. The instruction may further cause the system to receive a second acknowledgement packet that acknowledges the second grant and indicates that data is expected to be transmitted by the third wireless device over the communication channel within the time period. The instruction may further cause the system to power down receiving circuitry for the communication channel to the low power mode. The instruction may further cause the system to receive a second CTS packet that indicates the third wireless device is now ready to transmit other data over the communication channel using the second grant and then power up the receiving circuitry to receive one or more second data packets from the third wireless device including the other data.

In some examples for the second at least one machine readable medium, the communication channel may be reserved based on implementing a CSMA/CA scheme.

According to some examples for the second at least one machine readable medium, the first wireless device may be arranged to operate in compliance with one or more wireless communication standards or specifications associated with Institute of Electrical and Electronic Engineers (IEEE) 802.11 standards.

In some examples for the second at least one machine readable medium, the RDG packet may include an RDG PPDU having an MPDU that also includes a network address assigned to the second wireless device, indicates a time period for the grant that is less than the TxOP time period and an RDG/MPPDU bit set to 1 in a quality of service (QoS) field.

According to some examples for the second at least one machine readable medium, the RDG PPDU may be transmitted over the communication channel using a non-control MCS that includes an MCS greater than 0.

In some examples for the second at least one machine readable medium, the acknowledgment packet may include a first response PPDU having an MPDU including an RDG/MPPDU bit set to 1 in a QoS field that also indicates no data with the first response PPDU.

According to some examples for the second at least one machine readable medium, the one or more data packets may include a plurality of second response PPDUs each having a separate MPDU that includes the RDG/MPPDU bit. For these examples, at least an initial second response PPDU including the RDG/MPPDU bit set to 1 and a last second response PPDU including the RDG/MPPDU bit set to 0 to indicate no additional data is expected during the time period.

In some examples for the second at least one machine readable medium, the first response PPDU and the plurality of second response PPDUs may be transmitted over the communication channel using a non-control MCS that includes an MCS greater than 0.

According to some examples for the second at least one machine readable medium, the CTS packet may be received over the communication channel based on use of a control MCS that includes an MCS equal to 0. For these examples, the MCS equal to 0 may enable the first wireless device to receive the CTS packet while the receiving circuitry is powered down to the low power mode.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
a processor circuit for a first wireless device;
a grant component for execution by the processor circuit to receive a reverse direction grant (RDG) packet that indicates a grant for a transmitting data over a communication channel for a wireless local access network (WLAN) reserved for use by a second wireless device during a transmit opportunity (TxOP) time period;
an acknowledgement component for execution by the processor circuit to cause an acknowledgement packet to be transmitted that acknowledges the grant and indicates that data is expected to be transmitted over the communication channel within the TxOP time period;
a ready component for execution by the processor circuit to cause a clear-to-send (CTS) packet to be transmitted responsive to receiving data to transmit, the CTS packet to indicate to the second wireless device that the expected data is now ready to be transmitted over the communication channel using the grant; and
a data component for execution by the processor circuit to cause one or more data packets that include the received data to be transmitted over the communication channel.

2. The apparatus of claim 1, comprising the first wireless device arranged to operate in compliance with one or more wireless communication standards or specifications associated with Institute of Electrical and Electronic Engineers (IEEE) 802.11 standards including IEEE 802.11-2012.

3. The apparatus of claim 2, the RDG packet comprising an RDG physical layer protocol data unit (PPDU) that also includes a network address assigned to the first wireless device and indicates a first time period for the grant that is less than the TxOP time period.

4. The apparatus of claim 3, the acknowledgment packet comprising a first response PPDU having a media access control (MAC) protocol data unit (MPDU) including an RDG/more PPDU (MPPDU) bit set to 1 in a quality-of-service (QoS) field that also indicates no data with the first response PPDU.

5. The apparatus of claim 4, the one or more data packets comprising a plurality of second response PPDUs each having a separate MPDU that includes the RDG/MPPDU bit in the QoS field, at least an initial second response PPDU including the RDG/MPPDU bit set to 1 and a last second response PPDU including the RDG/MPPDU bit set to 0 to indicate no additional data is expected during the first time period.

6. The apparatus of claim 2, comprising the CTS packet transmitted over the communication channel using a control modulation and coding scheme (MCS) that includes an MCS equal to 0 that enables the second wireless device to receive the CTS packet while receiving circuitry at the second wireless device is powered down to a low power mode.

7. A method comprising:
receiving, at a first wireless device, a reverse direction grant (RDG) packet that indicates a grant for transmitting data over a communication channel for a wireless local access network (WLAN) reserved for use by a second wireless device during a transmit opportunity (TxOP) time period;
transmitting an acknowledgement packet to acknowledge the grant and indicate that data is expected to be transmitted over the communication channel within the TxOP time period;
transmitting a clear-to-send (CTS) packet responsive to receiving data to transmit, the CTS packet to indicate to the second wireless device that the expected data is now ready to be transmitted over the communication channel using the grant; and
transmitting one or more data packets including the received data over the communication channel.

8. The method of claim 7, comprising:
powering off receiving and transmitting circuitry for the communication channel following transmission of the acknowledgement packet; and
powering on at least the transmitting circuitry to transmit the one or more data packets.

9. The method of claim 7, comprising:
transmitting an indication that the expected data has been transmitted and no additional data is expected during the TxOP time period, the indication included with a last data packet transmitted from among the one or more data packets.

10. The method of claim 7, comprising the communication channel reserved based on implementing a carrier sense multiple access with collision avoidance (CSMA/CA) scheme.

11. The method of claim 7, comprising the first and second wireless devices arranged to operate in compliance with one or more wireless communication standards or specifications associated with Institute of Electrical and Electronic Engineers (IEEE) 802.11 standards including IEEE 802.11-2012.

12. The method of claim 10, the RDG packet comprising an RDG physical layer protocol data unit (PPDU) that also includes a network address assigned to the first wireless device and indicates a first time period for the grant that is less than the TxOP time period.

13. The method of claim 12, comprising the RDG PPDU received over the communication channel using a non-control modulation and coding scheme (MCS) that includes an MCS greater than 0.

14. The method of claim 12, the acknowledgment packet comprising a first response PPDU having a media access control (MAC) protocol data unit (MPDU) including an RDG/more PPDU (MPPDU) bit set to 1 in a quality-of-service (QoS) field that also indicates no data with the first response PPDU.

15. The method of claim 14, the one or more data packets comprising a plurality of second response PPDUs each having a separate MPDU that includes the RDG/MPPDU bit in the QoS field, at least an initial second response PPDU including the RDG/MPPDU bit set to 1 and a last second response PPDU including the RDG/MPPDU bit set to 0 to indicate no additional data is expected during the first time period.

16. The method of claim 14, comprising the first response PPDU and the plurality of second response PPDUs transmitted over the communication channel using a non-control modulation and coding scheme (MCS) that includes an MCS greater than 0.

17. The method of claim 11, comprising the CTS packet transmitted over the communication channel using a control modulation and coding scheme (MCS) that includes an MCS equal to 0 that enables the second wireless device to receive the CTS packet while receiving circuitry at the second wireless device is powered down to a low power mode.

18. An apparatus for comprising:
a processor circuit for a first wireless device;
a grant component for execution by the processor circuit to cause a reverse direction grant (RDG) packet to be transmitted that indicates a grant for a second wireless device to transmit data over a communication channel for a wireless local access network (WLAN) reserved for use by the first wireless device during a transmit opportunity (TxOP) time period;
an acknowledgement component for execution by the processor circuit to receive an acknowledgement packet that acknowledges the grant and indicates that data is expected to be transmitted over the communication channel within the TxOP time period;
a power component for execution by the processor circuit to power down receiving circuitry for the communication channel to a low power mode;
a ready component for execution by the processor circuit to receive a clear-to-send (CTS) packet that indicates the second wireless device is now ready to transmit data included in one or more data packets over the communication channel using the grant; and
the power component to cause the receiving circuitry to power up to receive the one or more data packets from the second wireless device.

19. The apparatus of claim 18, comprising the first device arranged to operate in compliance with one or more wireless communication standards or specifications associated with Institute of Electrical and Electronic Engineers (IEEE) 802.11 standards.

20. The apparatus of claim 19, comprising the CTS packet received over the communication channel based on use of a control modulation and coding scheme (MCS) that includes an MCS equal to 0 that enables the first wireless device to receive the CTS packet while the receiving circuitry has been powered down to the low power mode.

21. At least one machine readable medium comprising a plurality of instructions that in response to being executed on a system at a first wireless device cause the system to:
transmit a reverse direction grant (RDG) packet to indicate a grant for a second wireless device to transmit data over a communication channel for a wireless local access network (WLAN) reserved for use by the first wireless device during a transmit opportunity (TxOP) time period;
receive an acknowledgement packet that acknowledges the grant and indicates that data is expected to be transmitted over the communication channel within the TxOP time period;
power down receiving circuitry for the communication channel to a low power mode;
receive a clear-to-send (CTS) packet that indicates the second wireless device is now ready to transmit data included in one or more data packets over the communication channel using the grant; and
power up the receiving circuitry to receive the one or more data packets from the second wireless device.

22. The at least one machine readable medium of claim 21, the instructions to further cause the system to:
receive an indication that the expected data has been transmitted and no additional data is expected during the TxOP time period, the indication included with a last data packet transmitted from the second device from among the one or more data packets.

23. The at least one machine readable medium of claim 2, the instructions to further cause the system to:
transmit a second RDG packet to indicate a second grant for a third wireless device to transmit data over the communication channel during the TxOP time period, the second grant having a time period no greater than an amount of remaining time for the TxOP time period;
receive a second acknowledgement packet to acknowledge the second grant and indicate that data is expected to be transmitted by the third wireless device over the communication channel within the time period;
power down receiving circuitry for the communication channel to the low power mode;
receive a second CTS packet that indicates the third wireless device is now ready to transmit other data over the communication channel using the second grant; and
power up the receiving circuitry to receive one or more second data packets from the third wireless device including the other data.

24. The at least one machine readable medium of claim 21, comprising the first device arranged to operate in compliance with one or more wireless communication standards or specifications associated with Institute of Electrical and Electronic Engineers (IEEE) 802.11 standards.

25. The at least one machine readable medium of claim 24, comprising the CTS packet received over the communication channel based on use of a control modulation and coding scheme (MCS) that includes an MCS equal to 0 that enables the first wireless device to receive the CTS packet while the receiving circuitry is powered down to the low power mode.
